(19) United States
(12) Patent Application Publication
(10) Pub. No.: US 2004/0231455 A1
(43) Pub. Date: Nov. 25, 2004

(54) Pedal for a bicycle

(76) Inventor: Gerhard Hilber, St. Johann in Tirol (AT)

Correspondence Address: WILLIAM COLLARD, COLLARD & ROE, P.C., 1077 NORTHERN BOULEVARD, ROSLYN, NY, 11576, US

(21) Appl. No.: 10/481,538

(22) PCT Filed: Jun. 7, 2002
(86) PCT No.: PCT/AT02/00172

(30) Foreign Application Priority Data
Jun. 18, 2001 (AT) A 939/2001

(51) Int. Cl. G05G 1/14

(52) U.S. Cl. 74/594.4

(57) ABSTRACT

A pedal for a bicycle is described, comprising a sleeve (4) which is rotatably held on a pedal axle (1) and comprises a pedal forming a forefoot support (8) and a metatarsus support (9) which is joined to the pedal and is inclined with respect to the forefoot support (8). In order to provide advantageous constructional conditions it is proposed that the pedal consists of a pedal bracket (3) with two legs (10, 11) of which the leg (11), which is at the rear with respect to the foot support, is extended towards the metatarsus support (9).

### BACKGROUND OF THE INVENTION

The invention relates to a pedal for a bicycle with a sleeve which is rotatably held on a pedal axle and comprises a pedal forming a forefoot support and a metatarsus support which is joined to the pedal and is inclined with respect to the forefoot support.

### DESCRIPTION OF THE PRIOR ART

In order to additionally support the foot between the ball of the foot and the heel it is known (CH 290 481 A, FR 2 407 120 A) to provide the pedal of a bicycle with a metatarsus support protruding towards the heel. Said known metatarsus supports form complex constructions, however, because they either need to be rigidly connected with the pedal hub (CH 290 481 A) or need to be screwed onto the pedal as a bracket (FR 2 407 120 A).

In order to allow a movement of the foot in bicycle pedals not only about the pedal axle, but also about an axis in the longitudinal direction of the foot, it is known (WO 00/61428 A1) to swivelably support a pedal bracket forming a forefoot support on a bearing axle perpendicular to the pedal axle, which bearing axle is formed by radial noses on a sleeve which is held freely rotatable on the pedal axle. The sleeve is provided with an axial nose extended beyond the pedal axle which engages by means of a rubber-elastic ring in an opening of the pedal bracket, so that the pedal bracket is swivelably held only within limits on the bearing axle extending transversally to the pedal axle. Despite the thus resulting advantageous adjustment possibilities of the pedal to the respective foot posture, it is still necessary to transmit the force of the leg via the forefoot zone onto the pedal, leading to a respective strain on the foot. One should consider in this connection that during cycling the forefoot is subjected to bending with respect to the metatarsus, so that the force is transmitted onto the pedal via the bent forefoot. The muscular apparatus holding the forefoot in the bent position is therefore also strained in a respective manner, which leads to early fatigue in untrained cyclists.

### SUMMARY OF THE INVENTION

The invention is based on the object of providing a pedal for a bicycle of the kind mentioned above in such a way that with a simple, low-weight construction an advantageous support of the bent forefoot is achieved and favorable constructional conditions are created in order to enable an additional adjustment of the foot posture concerning an axis extending in the longitudinal direction of the foot.

The object in accordance with the invention is achieved in such a way that the pedal consists of a pedal bracket with two legs, of which the leg which is the rear one with respect to the foot support is extended towards the metatarsus support.

As a result of the one-sided extension of the pedal bracket towards a metatarsus support which is inclined with respect to the forefoot support, it is possible to predetermine an angle between forefoot and metatarsus which is advantageous for cycling, so that for maintaining a respective foot posture with bent forefoot no muscular power is required. The metatarsus support of the extended pedal bracket which is respectively inclined with respect to the forefoot support predetermines said angular position for the foot. Despite said additional metatarsus support a low-weight construction is ensured because it is only necessary to extend the leg of the pedal bracket which is the rear one with respect to the foot support.

In order to enable a simple adjustment of the bent foot support of the pedal bracket to the anatomical requirements of a cyclist, the metatarsus support can consist of a supporting leg which is held in a swivelably adjustable way at a bent leg end of the pedal bracket and which thus determines the angular position of the metatarsus with respect to the forefoot defined by the forefoot support.

To ensure that a foot posture is achieved which is favorable with respect to the pedal axle and no longer requires a forefoot support which is symmetrical with respect to the pedal axle due to the support of both the forefoot as well as the metatarsus, the radial distance of the swivel bearing of the rear leg of the forefoot support from the pedal axle can be chosen smaller than that of the front leg. As a result of said forward displacement of the forefoot support, it is thus easily possible to take into account the pedal strain which changes by the pedal bracket arrangement in accordance with the invention in order to allow the resulting foot force to attack the pedal as much as possible in the zone of the pedal axle, so that no additional torques result on the pedal which need to be absorbed by the muscular system of the foot or leg.

Due to the foot support both in the forefoot as well as the metatarsus zone, the compensation of tilting movements of the foot about an axis extending in the longitudinal direction of the foot gains, in importance. This known stop-limited swiveling of the pedal about a transversal axis towards the pedal axle can be solved in a particularly advantageous manner in a pedal in accordance with the invention. For this purpose the sleeve merely needs to form a bearing axle for the pedal bracket which extends transversally to the pedal axle, which pedal bracket is then held via the two legs about said bearing axle in a manner so as to be swivelable within limits, namely together with the metatarsus support extending the rear leg. The swiveling of the pedal bracket about an axis extending in the longitudinal direction of the foot should preferably occur against the force of a spring determining the middle position for the pedal bracket. A constructional possibility for such a spring-actuated support is obtained when especially the rear leg of the forefoot support is provided at a distance from the bearing axle with a receiving opening for an elastic supporting ring which is disposed on a radial support nose of the sleeve. Another possibility is supporting the pedal bracket on a bending rod extending in the direction of the pedal shaft and clamped on the sleeve. If such a bending rod is not enough for the limiting of the swiveling, the swiveling movement of the pedal bracket about the bearing axle extending transversally to the pedal axle can be limited in addition by stops.

### BRIEF DESCRIPTION OF THE DRAWINGS

The subject matter of the invention is shown by way of example in the drawings, wherein:

FIG. 1 shows a pedal in accordance with the invention for a bicycle in a side view;

FIG. 2 shows said pedal in a top view;

FIG. 3 shows a representation in accordance with FIG. 2 of a constructional variant of a pedal in accordance with the invention.

### DETAILED DESCRIPTION OF THE PREFERRED EMBODIMENTS

The pedal according to the illustrated embodiment is provided with a pedal axle 1 with a threaded neck 2 for fastening to the pedal crank of a bicycle and a pedal bracket 3 for foot support. Said pedal bracket 3 is not held directly on the pedal axle 1, but instead on a sleeve 4 which is freely rotatable about the pedal axle 1. For this purpose the sleeve 4 is provided with radial noses 5 and 6 which produce a bearing axle 7 for the pedal bracket 3, which axle extends transversally to the pedal axle 1.

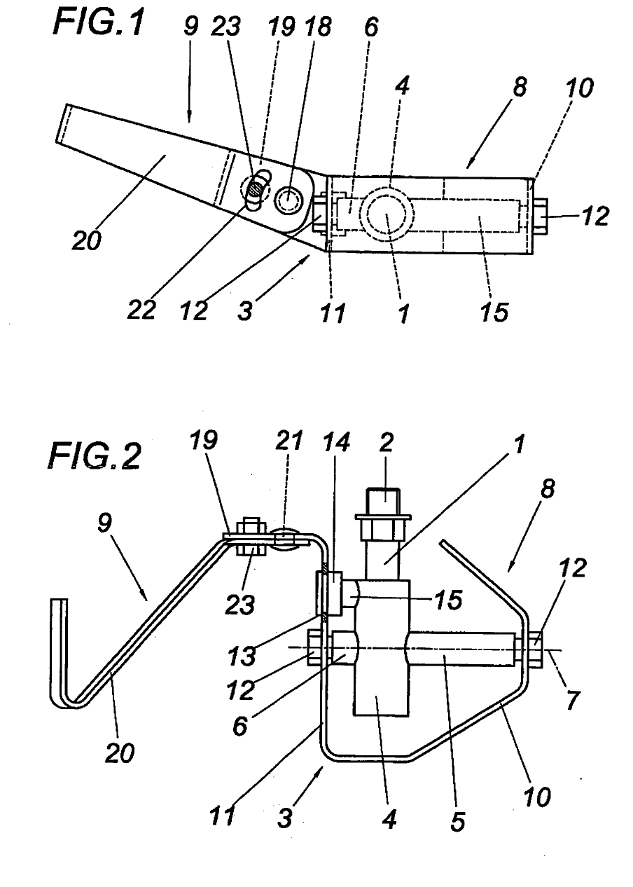

The pedal bracket 3 not only forms a forefoot support 8, but also a metatarsus support 9 which is provided win an angle of inclination with respect to the forefoot support 8, as is shown in FIG. 1. The forefoot support 8 is shaped by a leg 10 which is at the front with respect to the foot support and a back leg 11 of the pedal bracket 3. Said legs 10 and 11 are swivelably fastened with the help of screws 12 to the radial noses 5 and 6 of sleeve 4. According to FIG. 2, the rear leg 11 of the forefoot support 8 is provided with a receiving opening 13 for a rubber-elastic ring 14 which is fastened to a radial supporting nose 15 of the sleeve 4 in such a way that by way of the elastic ring 14 the pedal bracket 3 can be swiveled in a limit-stopped manner about the bearing axle 7 against the restoring force of the rubber-elastic ring 14.

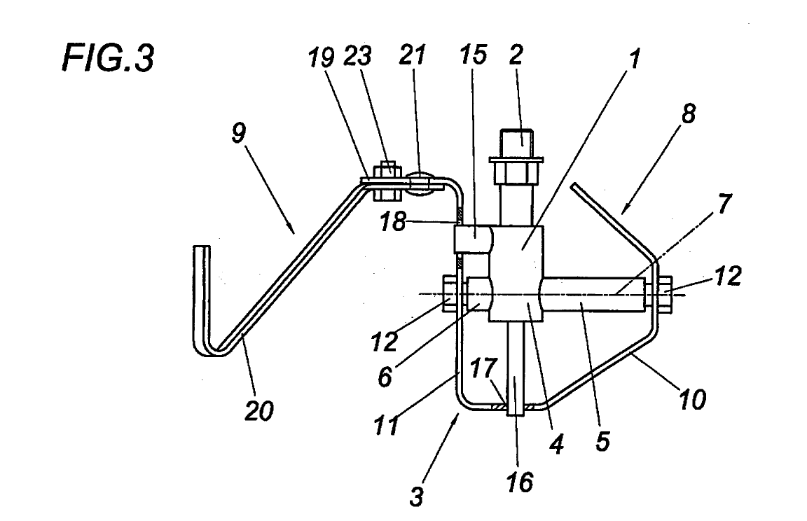

For the spring-actuated support of the pedal bracket 3, a bending bar 16 is provided according to the embodiment according to FIG. 3, which bending bar is attached in a deflection-resistant manner on the face side of sleeve 4 and engages in a bore 17 of the pedal bracket 3. Since the spring bar 16 extends transversally to the bearing axle 7, the pedal bracket 3 can only be swiveled by bending the bending bar 16 about the bearing axle 7. To ensure that the swiveling movement of the pedal bracket 3 can be limited irrespective of the flexural strength of the bending rod 16, the radial supporting nose 15 of sleeve 4 is used as a swivel stop. For this purpose the supporting nose 15 engages with radial play in a recess 18 of the rear leg 11 of the pedal bracket 3.

The metatarsus support 9 is adjustable with respect to the forefoot support 8 concerning the angle of inclination. From a constructional viewpoint this adjustability of the angle of inclination is achieved in such a way that a supporting leg 20 of the metatarsus support 9 is coupled to the rearwardly bent end 19 of the rear leg 11 of the forefoot support 8. Said coupling occurs via a preferably riveted axle 21, to which an oblong hole 22 is provided concentrically in the supporting leg 20 which is penetrated by a clamping screw 23 held in the leg end 19. As a result of said clamping screw 23, the respectively set inclination of the supporting leg 20 can be determined with respect to the forefoot support 8.

As is shown especially in FIGS. 2 and 3, the radial nose 6 of sleeve 4 is shorter than the opposite nose 5, so that an off-center position is obtained for the forefoot support 8 with respect to the pedal axle 1. The thus produced forward displacement of the pedal bracket 3 takes into account the different force conditions arising from the foot support both in the forefoot and metatarsus regions.

1. A pedal for a bicycle with a sleeve (4) which is rotatably held on a pedal axle (1), which sleeve comprises a pedal forming a forefoot support (8) and a metatarsus support (9) which is joined to the pedal and is inclined with respect to the forefoot support (8), characterized in that the pedal consists of a pedal bracket (3) with two legs (10, 11) of which the leg (11) which is at the rear with respect to the foot support is extended towards the metatarsus support (9).

2. A pedal as claimed in claim 1, wherein the metatarsus support (9) consists of a supporting leg (20) which is swivelably adjustably held on a bent leg end (19) of the pedal bracket (3).

3. A pedal as claimed in claim 1, wherein the radial distance of the swivel bearing of the rear leg (11) of the forefoot support (8) from the pedal axle can be chosen smaller than that of the front leg (10).

4. A pedal as claimed in claim 1, wherein the sleeve (4) comprises a bearing axle (7) for the pedal bracket (4) which extends transversally to the pedal axle (1), which pedal bracket is held swivelably within limits about said bearing axle (7) through said the legs (10, 11).

5. A pedal as claimed in claim 4, wherein especially the rear leg (11) of the forefoot support (8) is provided at a distance for the bearing axle (7) with a receiving opening (13) for an elastic supporting ring (14) which is disposed on a radial support nose (15) of the sleeve (4).

6. A pedal as claimed in claim 4, wherein the pedal bracket (3) is supported on a bending bar (16) which extends in the direction towards the pedal axles (1) and is clamped on the sleeve (4).
